(19) United States
(12) Patent Application Publication
(10) Pub. No.: US 2014/0317990 A1
(43) Pub. Date: Oct. 30, 2014

(54) Fishing Rod Holder

(71) Applicant: Alvan D. Spiegel, Washington, PA (US)

(72) Inventor: Alvan D. Spiegel, Washington, PA (US)

(73) Assignee: Erin Ward Spiegel, Valdese, NC (US)

(21) Appl. No.: 13/872,603

(22) Filed: Apr. 29, 2013

(51) Int. Cl. A01K 97/10

(52) U.S. Cl. CPC A01K 97/10
USPC 43/21.2

(57) ABSTRACT

A fishing rod holder for shore-based fishing, comprising a base having two or more recesses, each recess adapted to receive a rod having a fishing rod receiving end at its top end. Mating hook and loop closures on the base and rod shafts allow the rods to be stowed against the base in a storage or transit position. A handle on one long side of the base allows easy transport. Each pair of rods features rods of two lengths: a shorter rod approximately two thirds the length of the longer rod. When the shorter rod is placed closer to the water's edge relative to the longer rod, this orientation is typically used for carp or catfish fishing. When the rod position is reversed, this orientation is suitable for bass or bluegill fishing. A second embodiment allowing multiple rods to be held at the same time is also provided.

### TECHNICAL FIELD

The present invention pertains to the field of fishing equipment. More particularly, the present invention pertains to fishing rod holders designed for shore or land based fishing.

### BACKGROUND OF THE INVENTION

Shore fishing is a popular recreational pastime, where a fisherman standing or sitting along the shoreline of a lake or pond casts his line into the water, and then waits for a fish to bite. A bobber, a floating and often colorful indicator, is generally affixed to the fishing line, and indicates to the fisherman that a fish is on the line when the bobber starts moving around. With the types of fish generally caught with shore fishing, for instance, carp, catfish, bass, and bluegill, and the fact that often the sole indication that a fish has been caught is movement of the bobber, a main requirement of shore fishing is holding the fishing rod still for long periods of time.

Fishing rod holders make shore fishing less tedious, but a problem with currently available holders is that since the fish may grab the hook and try to swim away, the holder cannot be flimsy, or else the fish will pull the entire rod and holder into the water. Hence, fishing rod holders are often staked into the ground, requiring a mallet or other necessary (and heavy) tools, thus burdening the fisherman with more things to carry to the shore side. Further, staking is sometimes impossible if the shoreline is rocky, or if the fisherman lacks the physical strength to pound in the stakes.

What is needed is a fishing rod holder that is conveniently portable and compact, does not require extra tools to assemble, is substantial enough to resist the force of the fish pulling on the line, is easily modified for use when catching different types of fish, and is both economical and able to withstand the elements and years of use.

### DISCLOSURE OF INVENTION

The invention provides a fishing rod holder for shore fishing, comprising a base with at least two spaced apart recesses in a top face surface of the base, each recess adapted to receive a bottom end of a rod, the rod further having a fishing rod receiving end, typically a U-shaped bracket, at its top end. The rods are of different lengths, with the longer rod being about one third longer than the shorter rod. Hook and loop strips are affixed to the face side of the base, with the corresponding mating strips also affixed around the circumference of the rods. A handle is affixed securely to one edge of the base. To assemble, the bottom end of each rod is inserted into a recess, with the fishing rod receiving ends parallel to one another such that the fishing rod receiving ends are oriented so that the space between the arms of the U shaped brackets are both parallel to the shortest side of the base and to each other. The shorter rod is placed at a base first end, and the longer rod is placed in the remaining recess at the base second end. For carp or catfish fishing, the base is oriented so that the shorter first rod is placed closer to the water's edge, relative to the longer second rod. A fishing rod is placed in the fishing rod receiving ends, with the line directed towards the water, such that the handle of the fishing rod is furthest from the water, and the tip of the fishing rod is pointing towards the water, at about a 10 degree angle below horizontal. For bass or bluegill fishing, the orientation of the base is reversed, so that the longer second rod is placed closer to the water's edge, relative to the shorter first rod, and such that the tip of a fishing rod placed in the fishing rod receiving ends will be tilting upwards approximately 10 degrees above the horizontal. Another embodiment is designed to allow two fishing rods to be held at the same time, by including more recesses and rods, and by orienting the base so that the longer sides are parallel to the water. The rods may again be oriented as desired, and it is possible to have one set of rods oriented for carp or catfish fishing, and the other set oriented for bass or bluegill at the same time. To store or transport, the rods are removed from their respective recesses, and then the hook and look closures affixed to the rods are firmly pushed against the mating hook and loop closures on the base. The fisherman then carries the holder by holding the handle.

### BRIEF DESCRIPTION OF THE DRAWINGS

The features and advantages of the invention will become apparent from a consideration of the subsequent detailed description presented in connection with accompanying drawings, in which:

FIG. 1 is a top view a base of a fishing rod holder according to the invention, shown in storage position.

FIG. 2 is a top view of a base of the fishing rod holder of FIG. 1, showing the base and a plurality of receiving holes.

FIG. 3 is a side elevational view of an assembled fishing rod holder according to the invention.

FIG. 4 is a front elevational view of the assembled fishing rod holder shown in FIG. 3.

### DRAWINGS LIST OF REFERENCE NUMERALS

The following is a list of reference labels used in the drawings to label components of different embodiments of the invention, and the names of the indicated components.

10 fishing rod holder

12 base or board 12a base first end 12b base second end base second end 12c base face 12d base first side (handle side) 12e base second side

14 hook and loop closure

16 first rod

16a first rod top end

16b first rod bottom end

18 second rod

18a second rod top end

18b second rod bottom end

20 u-shaped bracket or u-shaped fishing rod receiving end

22a first recess

22b second recess

22c third recess

22d fourth recess

24 carrying handle

40 fishing rod

### DETAILED DESCRIPTION

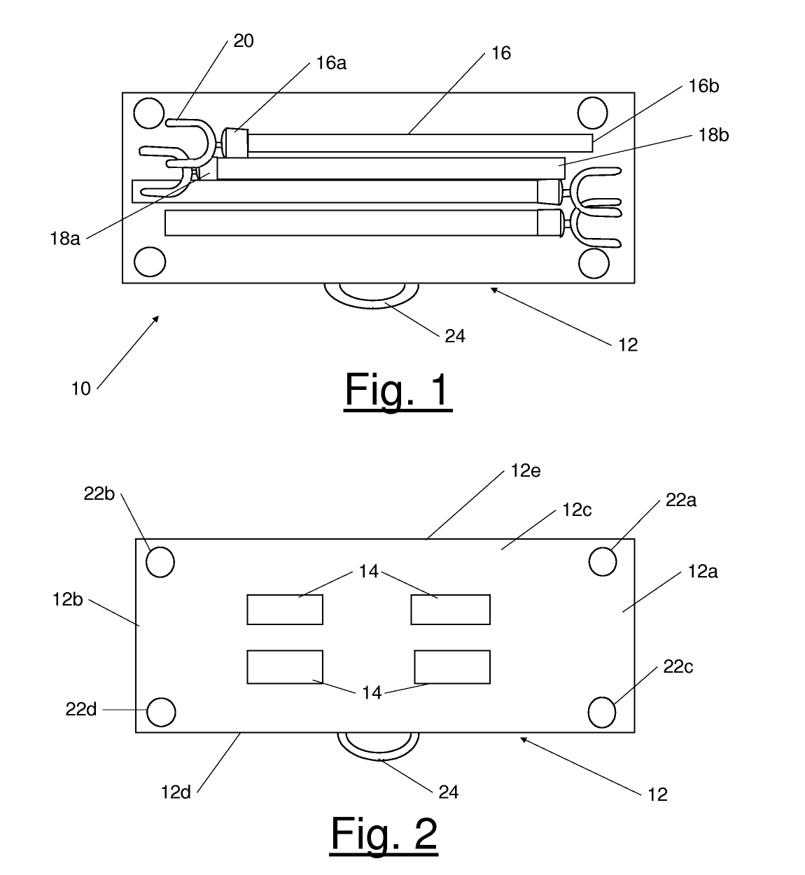

Referring now to FIGS. 1-4, a fishing rod holder 10 according to the invention is provided in a transit or storage position, comprising a base 12 having a base face 12c, a base first end 12a and a base second end 12b. Hook and loop closures 14 are affixed to the base face 12c and also along a portion of a shaft of a first rod 16 and also on a second rod 18, the hook and loop closures for attaching the rods 16 18 to the base face 12c. The hook and loop closures on the rods 16 18 are pressed securely into the mating hook and loop closures on the base face 12c.

The first rod 16 is further comprised of a top end 16a and a bottom end 16b. The second rod 18 is further comprised of a top end 18a and a bottom end 18b. A U-shaped bracket 20 is secured to the top end 16a 18a of each rod 16 18. The primary difference between the rods 16 18 is that the first rod 16 is approximately two-thirds the length of the second rod 18 in a preferred embodiment, and generally the first rod 16 is shorter than the second rod 18 so that a fishing pole 40 resting in the U shaped brackets 20 will rest in the brackets at an angle. A handle 24 is affixed to one edge of the base 12 to allow a user to easily transport the fishing rod holder 10.

FIG. 2 shows the base 12 and a plurality of recesses 22a-d, the recesses adapted to receive the bottom ends 16b 18b of the rods 16 18.

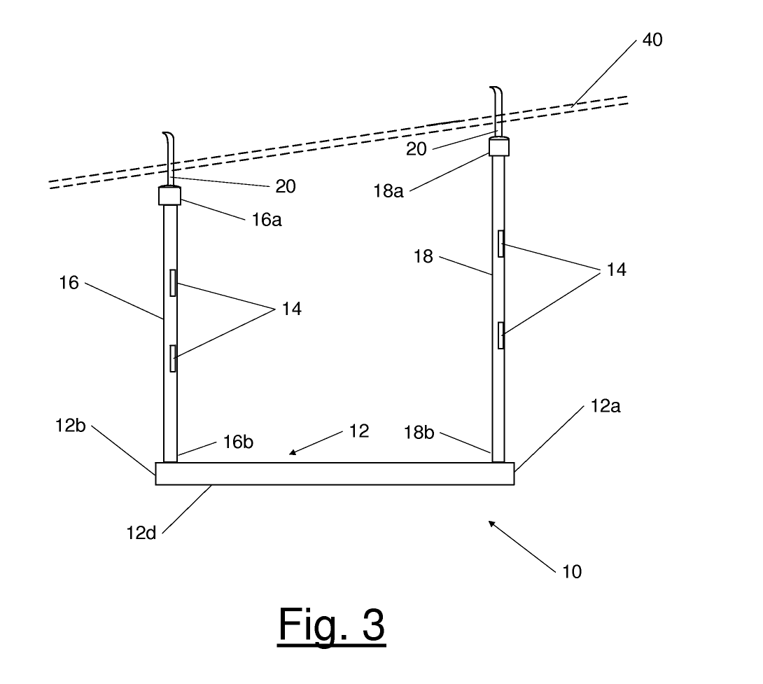

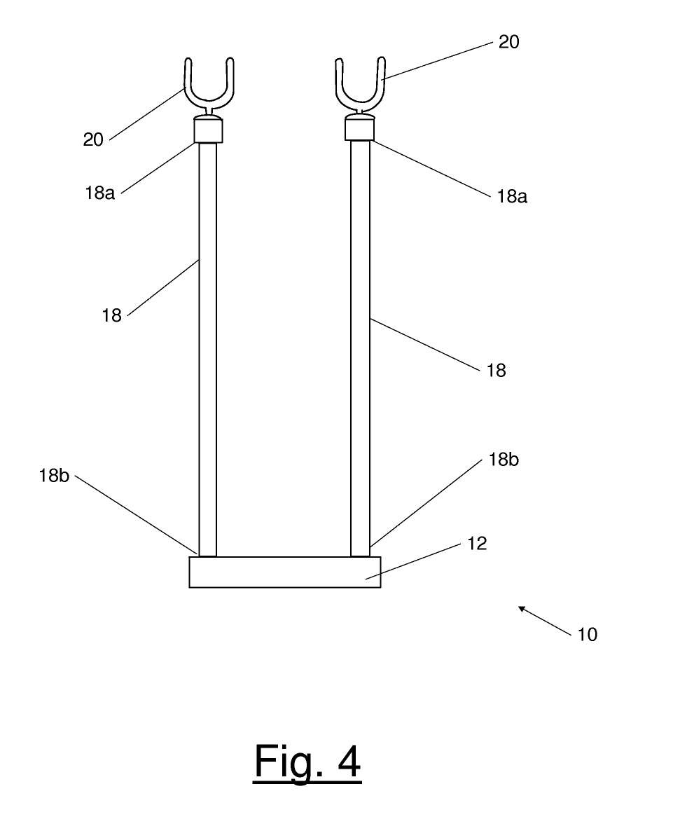

Referring now to FIGS. 3-4, the fishing rod holder 10 is shown in its assembled position. To assemble, the rods 16 18 are removed from the hook and loop closures 14 on the base face 12c, then each rod is inserted into a desired recess 22a 22b, depending on the type of fish the user wants to catch. The U-shaped brackets 20 are oriented so that the arms of the bracket are parallel, such that a fishing rod can be placed into the brackets 20. In FIG. 3, the base second end 12b is oriented so as to be closest to the water relative to the base first end 12a. When the shorter first rod 16 is inserted into the recess 22b, and the longer second rod 18 is inserted into the recess 22a, the fishing rod holder 10 is oriented for carp or catfish fishing, where the fishing rod 40 placed in the brackets 20 will be oriented with a tip (not shown) of the fishing rod angled towards the water surface, with the tip of the fishing rod angled about 10 degrees below the horizontal in a downwards orientation towards the water surface. If the base first end 12a is positioned closer to the water relative to the base second end 12b, the tip of fishing rod 40 held in the brackets 40 will be angled upwards and a handle (not shown) of the fishing rod will be positioned closer to the base 12 relative to the tip position, causing the fishing rod 40 to be angled about 10 degrees above the horizontal with the tip angling upwards, away from the water surface. This orientation of the fishing rod holder 10 is suitable for bass or bluegill fishing.

The rods 16 18 may be inserted into any recess 22a 22b, and either end of the base 12a 12b may be placed closer or further away from the water, depending on the type of fish sought. The plurality of recesses 22a-d and in some embodiments, such as the one shown in FIG. 1, allows two fishing rods 40 to be held by the fishing rod holder 10, and allowing two rods oriented the same way (tilted up or down), or one rod oriented to catch bass or bluegill, and the other oriented to catch carp. The user may thus easily assemble the rod holder 10 and then turn the holder to orient it as desired. In some embodiments, it is possible to orient the base 12 so that a base first side 12d or a base second side 12e is oriented closer to the water relative to the opposing side, allowing the fishing rod holder 10 to be positioned between two users, each user sitting at a first side 12a or a second side 12b, with the fishing rod holder 10 sandwiched between them. Alternatively, a single fisherman can sit on either end and use two rods at the same time. Again, the rods 16 18 may be oriented as desired.

The recesses 22a-d shown in the Figures may include a cup fitting inserted and sitting on the base face 12c, although the recesses 22a-d may simply be through bore-holes cut into the base 12 with or without a cup fitting. Both rods 16 18 are identical in composition, and the only difference is the length of each rod relative to the other. The recesses 22a 22d are also identical to one another, and the rods are interchangeable in the recesses.

It should be noted that the brackets 40 shown in the Figures are U-brackets, however other shaped brackets, such as Y-shaped, are also suitable, so long as the fishing rod 40 maybe easily placed into the bracket and held so that it cannot be easily displaced by a fish tugging on a fishing line threaded onto the fishing rod 40, or rolled out of the bracket by the user inadvertently bumping the fishing rod holder 10.

Suitable materials for use with the fishing rod holder 10 are screw in type metal U-shaped brackets, the brackets dipped so as to have a slide resistant surface, and schedule 40 pvc pipe. The U-shaped brackets are then easily screwed into the top end 16a 18a of the rod, and in the Figures, into a pvc end cap. In some embodiments, not shown, rod inserts are inserted in the rods 16 18 to further stabilized and strengthen the rods, particularly if the recesses are less than half the depth of the base 12. The plastic fittings for the recesses and the top cap over the end of the top end of the rods are all made of schedule 40 pvc. Other materials can be used for the rods, including wood or plastic dowels, metal, etc. The rods can be solid or hollow, and may be square, circular, or rectangular in cross section, as desired. A rectangular cross-sectioned rod would allow the fishing rod holder 10 in storage position (FIG. 1) to be more compact and sleek. It should also be noted that the rod bottom ends 16b 18b may also be threaded and screw into the recesses 22a-d.

The base itself is typically pressure treated lumber, but plastic or other materials are also suitable. It should be noted that the inventor feels that for stability, the base 12 material must be reasonably substantial, and hence has recommended using wood. It is also possible to make the fishing rod holder 10 out of hollow plastic for ease of transport, and with a hollow fillable base 12 that can be filled with water, sand or other suitable material, to make the base stable when used. Typically the base will be rectangular, although other shapes are permissible. The fishing rod holder will have a total weight of typically about 8-10 pounds if wood is used for the base, or about 6 pounds or less if plastic is used for the base, with the majority of the weight being attributed to the base itself. A less heavy base may be used, and can be created easily by using a shape other than a rectangle, but lighter bases increase the risk of a fish pulling the rod holder 10 into the water.

The handle 24 is typically made of metal for durability, although any other suitable handle material may also be used. The materials typically used for the fishing rod holder 10 according to the invention and described above result in an economical, long lasting holder, able to withstand years of outdoor use. More expensive and/or different materials may be used, for instance, wooden dowels may be substituted for the pvc pipe, and a furniture grade of wood may be used for the base 12, so long as the wood is treated with the appropriate finish to withstand outdoor use. Plastic is appropriate for all parts of the fishing rod holder 10, so long as the plastic or other materials are able to withstand exposure to the elements, particularly sun and moisture. The inventor feels that 14 and loop closures 14 are ideally suited to fasten the rods 16 18 to the base face 12c, however other fastening means are possible, such as straps. Additionally, the base face 12c may be configured with recesses adapted to hold the rods.

It is to be understood that the above-described arrangements are only illustrative of the application of the principles of the present invention. Numerous modifications and alternative arrangements may be devised by those skilled in the art without departing from the scope of the present invention. For instance, the base 12 can be modified to hold just one fishing rod, or more rods by staggering the pattern or recesses and/or making the pairs of rods 16 18 different dimension so as to have two or more height levels of rods. A small child, for instance, could sit on one end and have a pair of rods that maintain the same height ratio but are overall shorter in length compared to a second pair of rods used by an adult, allowing each user to have a comfortably positioned fishing rod holder. Staggering the heights of the pairs of rods is particularly suitable when space is limited.

I claim:

1. A fishing rod holder kit, the kit comprising:
a base (12);
at least two receiving recesses (22a 22b) in spaced-apart relation formed into the base (12);
a pair of rods, the pair of rods comprising a short rod (16) and a long rod (18), each of the rods (16 18) having a top end (16a 18a) and a bottom end (16b 18b);
at least two brackets (20), each bracket affixed to the top end (16a 18b) of each of the rods (16 18); and
wherein the at least two receiving recesses (22a 22b) are adapted to receive the bottom ends (16b 18b) of the pair of rods.

2. The fishing rod holder kit of claim 1, further comprising at least a second pair of rods.

3. The fishing rod holder kit of claim 1, wherein the rods (16 18) are affixed to the base (12) by hook and loop closures (14) affixed to both the rods and the base (12).

4. The fishing rod holder kit of claim 1, wherein the short rod (16) is two thirds the length of the long rod (18).

5. A fishing rod holder (10) for holding a fishing rod (40) used for fishing along the shore of a body of water, the fishing rod holder (10) comprising:
a base (12) having a base face (12c);
a first recess (22a) and a second recess (22b) in spaced-apart relationship formed into the base face (12);
a first pair of rod holders, the pair of rods further comprising at least one short rod (16) having a top end (16a) and a bottom end (16b), the bottom end (16b) inserted into the first recess (22a) and at least one long rod (18) having a top end (18a) and a bottom end (18b), the bottom end (18b) inserted into the second recess (22b);
a bracket (20) affixed to the top end (16a) of the at least one short rod (16) and a second bracket (20) affixed to the top end of the at least one long rod (18);
at least one long rod (18) having a top end (18a) and a bottom end (18b), the bottom end (18b) inserted in the second recess (22b);
wherein when the at least one short rod (16) is oriented closer to the body of water relative to the long rod (18), the fishing rod (40) supported by the brackets (20) is oriented such that a tip of the fishing rod is angled downwards towards the body of water, whereby the fishing rod is oriented for at least one of catfish and carp fishing, and
wherein when the at least one long rod (18) is oriented closer to the body of water relative to the at least one short rod (16), the fishing rod (40) supported by the brackets (20) is oriented such that the tip of the fishing rod (40) is angled upwards and away from the body of water, whereby the fishing rod is oriented for at least one of bass and bluegill fishing.

6. The fishing rod holder of claim 5, further comprising at least a second pair of rod holders of a different height relative to the first pair of rods holders, whereby the fishing rod and a second fishing rod are held side by side in the first and second pairs of rod holders, but the first pair of rod holders holds the fishing rod parallel to and above the plane in which the second pair of rod holders hold the second fishing rod, whereby two users of different heights may be comfortably accommodated by the staggered heights of the pairs of rod holders.

7. The fishing rod holder (10) of claim 5, wherein the base (12) has a hollow core that is fillable with at least one of water and granular material, whereby the user can fill and empty the base (12) as necessary to vary the weight of the fishing rod holder (10)

8. The fishing rod holder (10) of claim 5, wherein the rods (16 18) are made of hollow plastic pipe.

9. The fishing rod holder (10) of claim 8 further comprising a rod insert removably inserted inside the rods (16 18).

10. The fishing rod holder (10) of claim 5, wherein the short rod (16) is two-thirds the length of the long rod (18).
